(19) United States
(12) Patent Application Publication
(10) Pub. No.: US 2007/0271419 A1
(43) Pub. Date: Nov. 22, 2007

(54) Memory administrating method

(75) Inventors: Masayuki Yasukaga, Tokyo (JP); Tomohiro Suzuki, Tokyo (JP); Yuji Tamura, Tokyo (JP); Tetsuya Ishikawa, Tokyo (JP); Hiroyasu Nishimura, Tokyo (JP); Tomoya Ogawa, Tokyo (JP); Fumikage Uchida, Asaka-shi (JP); Nao Moromizato, Tokyo (JP); Munetoshi Eguchi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/706,228

(22) Filed: Feb. 15, 2007

(30) Foreign Application Priority Data
May 18, 2006 (JP) JP2006-138668

(51) Int. Cl. G06F 12/02

(52) U.S. Cl. 711/147

(57) ABSTRACT

A memory administrating method of administrating a memory divided into plural memory regions each of which consists of consecutive memory addresses, comprises steps of: acquiring a memory region from the plural memory regions; and registering at least one of usage information indicating the usage of the acquired memory region and time period information indicating the using time period for using the acquired memory region in an administrating portion of the acquired memory region.

This application is based on Japanese Patent Application No. 2006-138668 filed on May 18, 2006 in Japanese Patent Office, the entire content of which is hereby incorporated by reference.

### BACKGROUND OF THE INVENTION

The present invention relates to a memory administrating method for conducting dynamically acquisition and release of a memory region, particularly to a technique to efficiently share a memory for a plurality of different usages.

To ensure effective use of a memory resource, a computer apparatus adopts a dynamic memory administration in which each processing acquires a region of a required size whenever required, and releases the region after having used the region.

In such a memory administration, there are great differences in the size of the region to be acquired, and the time to release the region. If the process of acquisition and release is repeated, fragmented unused regions (vacant region) will occur and the memory region will be divided into discontinuous fragmented-regions. Thus, a continuous large-sized vacant region cannot be ensured, although a sufficient amount of regions is available as a total region.

In the conventional method, when a region 301 having been used is to be released, a check is made to see if there is any unused region before and after the region 301 to be released, as shown in FIG. 9. If there are unused neighboring regions 302 and 303, the region 301 to be released and the unused regions 302 and 303 are united into one unused region 304 (e.g., Unexamined Japanese Patent Publication No. H5-12099).

In a method of uniting a memory region with a neighboring unused memory region when releasing the memory region, if the memory region is not released, the effect according to the method can be obtained. For example, in a case that a memory region being in use for a usage in which the memory region is nor released for a long time period, is acquired between two unused regions, an event to create a large unused region by uniting the memory region with the two unused regions is not realized for a long time period.

Further, if, once, small size memory regions have been acquired so as to scatter at different places, thereafter, it may be difficult to create large successive regions. For example, the system memory may be shared for use as a region for image processing and a region for normal data processing by software. Since there are great differences in the size of a acquired region and the length of time period of use after acquisition until release between the region for image and that for software, it may be difficult to refrain sufficiently fragmentation of memory regions only by uniting a memory region with unused regions when releasing the memory region.

### SUMMARY OF THE INVENTION

In order to solve these problems, an object of the present invention is to provide a memory administrating method with which it may be difficult to cause fragmentation of memory regions even if memories are shared for plural usages having great differences in the size of a region to be acquired and the length of time period of use after acquisition of the region until release.

The above objects can be attained by a memory administrating method reflecting an aspect of the present invention as described in Item 1.

Item 1. A memory administrating method of administrating a memory divided into plural memory regions each of which consists of consecutive memory addresses, comprises steps of:

acquiring a memory region from the plural memory regions; and

registering at least one of usage information indicating the usage of the acquired memory region and time period information indicating the using time period for using the acquired memory region in an administrating portion for the acquired memory region.

### BRIEF DESCRIPTION OF THE DRAWINGS

FIG. 1 is a block diagram representing the structure of an image forming apparatus as an embodiment of the present invention;

FIG. 2 is an explanatory diagram showing an example of separating the image region into a plurality of blocks for processing in the image forming apparatus as an embodiment of the present invention;

FIG. 3 is an explanatory diagram showing an example of administration information of the memory region;

FIG. 4 is a flow chart showing the process of acquiring the memory region conducted by an image processing apparatus according to a first embodiment of the present invention;

FIG. 5 is an explanatory diagram showing a working condition of a memory and exemplifying a searching method for an assigned region on the working condition;

FIG. 6 is a flow chart showing the process of acquiring the memory region conducted by an image processing apparatus according to a second embodiment of the present invention;

FIG. 7 is an explanatory diagram showing a concrete example of a region acquisition in the acquiring process for a memory region in the second embodiment;

FIG. 8 is an explanatory diagram showing a concrete example of a region acquisition in the acquiring process for a memory region in the third embodiment;

FIG. 9 is flow chart showing the memory acquiring process adapted to set an unused region at a lower priority in the case that the usage information of the both in-use memory regions positioned before and after the unused memory region are the same to each other and different from that of a memory region to be acquired from now; and

FIG. 10 is an explanatory diagram showing a state that when releasing a memory region, the released region and regions positioned before and after the released region.

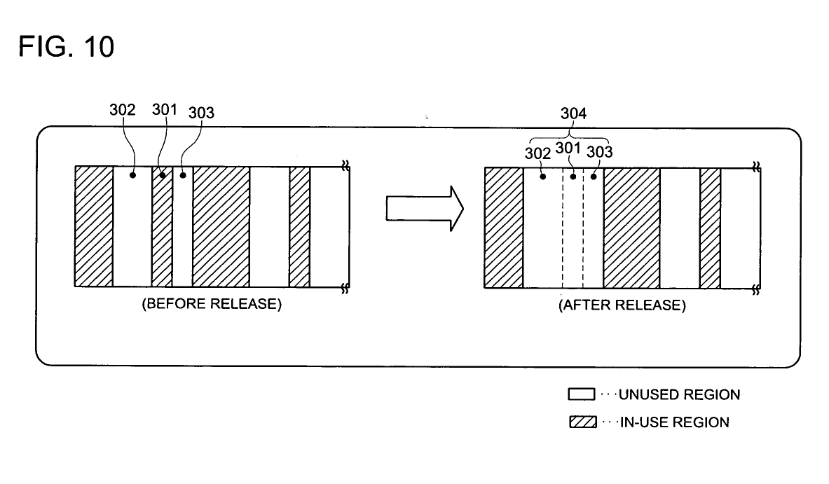

### DETAILED DESCRIPTION OF THE PREFERRED EMBODIMENT

Hereinafter, preferable embodiments of the present invention are explained, however, the present invention is not limited to these preferable embodiments.

Firstly, preferable memory administrating methods to attain the above objects are explained.

Item 2. In the memory administrating method described in Item 1, the usage information indicating a usage of the acquired memory region is preferably registered in the administrating portion of the acquired memory region.

In the embodiment described in Item 2, the usage information indicating a usage of the acquired memory region is registered in the administrating portion of the acquired memory region. The administrating portion may be provided at a leading portion or a trailing portion of the acquired memory region, or may be provided in an administrating table provided at another region separately from the acquired memory region. The usage information may be received as parameter at the time of receiving an acquiring request for a memory region from each process. The usage may be preferable to be classified so as to reflect differences from a size, a using time period, and other restriction (for example, presence or absence of boundary).

Item 3. In the memory administrating method described in Item 1, the time period information indicating a time period for using the acquired memory region is preferably registered in the administrating portion of the acquired memory region.

In the embodiment described in Item 3, the time period information indicating a time period for using the acquired memory region is registered in the administrating portion of the acquired memory region. The administrating portion may be provided at a leading portion or a trailing portion of the acquired memory region, or may be provided in an administrating table provided at another region separately from the acquired memory region. The time period information may indicates concretely a length of using time period or a date to lease the memory region with numeral values or may be plural stages to indicate long or short of the time period.

Item 4. In the memory administrating method described in Item 2, in the step of acquiring a requested memory region, a searching method of searching an assigned region to be assigned as the requested memory region is preferably determined in accordance with the usage of the requested memory region.

In the embodiment described in Item 4, for example, the usage information of the memory is received as a parameter of an acquiring request, and a searching method for an assigned region for the acquiring request at this time is determined in accordance with the usage indicated by this usage information. For example, searching from the leading portion of the memory or searching from the trailing portion of the memory may be switched or whether or not searching is conducted preferentially from the smallest-size unused region obtainable a requested size is determined in accordance with the usage.

This arrangement allows memory regions of the same usage to be assigned to a closer position with each other. Thus, separation is conducted based on the usage within the memory, and fragmentation is minimized. For example, in the case that there are big differences in region size depending on the usage, a zone where memory regions having large sizes are acquired and a zone where memory regions having relatively small sizes are acquired are positioned separately in the memory, thus fragmentation can be minimized.

Item 5. In the memory administrating method described in Item 3, in the step of acquiring a requested memory region, a searching method of searching an assigned region to be assigned as the requested memory region is preferably determined in accordance with the using time period for using the requested memory region.

In the embodiment described in Item 5, for example, the time period information of the memory is received as a parameter of an acquiring request, and a searching method for an assigned region for the acquiring request at this time is determined in accordance with the using time period indicated by this information. For example, searching from the leading portion of the memory or searching from the trailing portion of the memory may be switched or whether or not searching is conducted preferentially from the smallest-size unused region obtainable a requested size is determined in accordance with the using time period.

This arrangement allows memory regions having close using time periods to be assigned to a closer position with each other. Thus, separation is conducted based on the using time period within the memory, and fragmentation can be minimized. For example, a zone where memory regions having long using time period and a zone where memory regions having relatively short using time period and being release quickly are acquired are positioned separately in the memory, and events that regions having using time periods largely different from each other are positioned alternately with mixed arrangement become few, thus fragmentation can be minimized.

Item 6. In the memory administrating method described in Item 3, in the step of acquiring a requested memory region, the priority order of an unused region to be assigned as the requested memory region is preferably determined based on the usage information registered in the administrating portion for the acquired in-use memory regions.

In the embodiment described in Item 6, when assigning one of unused regions to a requested memory region to be acquired, the priority order of each of the unused regions is determined in accordance with the usage of the acquired in-use memory regions.

Item 7. In the memory administrating method described in Item 6, the priority order of an unused region is preferably determined based on a comparison result between the usage information registered in the administrating portion for the acquired in-use memory regions positioned in the vicinity of the unused region and the usage of the requested memory region to be acquired.

In the embodiment described in Item 7, the priority order is determined based on the conformity of the usage in comparison between the usage information of the acquired memory regions positioned in the vicinity of the unused region and the usage of the memory region to be acquired. For example, when the usage information of both the acquired memory regions positioned before and after the unused region is different from the usage of the memory region to be acquired from now, the priority order is made low. When the usage information of one of the acquired memory regions positioned before and after the unused region is same with the usage of the memory region to be acquired from now and that of the other one is different from the usage of the memory region to be acquired from now, the priority order is made middle. And, when the usage information of both the acquired memory regions is the same with that of the memory region to be acquired from now, the priority order is made high.

Namely, in the case that the usage information of both the acquired memory regions positioned before and after an unused region is the same with that of a memory region to be acquired from now, by preferentially using the unused region as an assigned region for the memory region to be acquire, the memory region is acquired such that memory regions having similar sizes and closer release timing are positioned close to each other. Therefore, when releasing a memory region, the memory region becomes to be easily united with a neighboring region, thereby minimizing fragmentation in memory regions. The memory regions in the vicinity of an unused region may not be limited to neighboring regions before and after the unused region and may be set to wider regions.

Item 8. In the memory administrating method described in Item 7, in the case that both memory regions neighboring at before and after the address of the unused memory region are in-use memory regions and the usage information of the both memory regions are the same with each other and are different from the usage of the requested memory region, the priority order of the unused memory regions is preferably set at a lower order.

In the embodiment described in Item 8, the probability that an unused region positioned between the acquired in-use regions having the same usage is used as a memory region used for a different usage from that of the acquired in-use regions positioned before and after, is made lower. With this, the possibility that the unused region is united with the regions positioned before and after as one continuous unused region, is made higher.

Item 9. In the memory administrating method described in Item 7, when the usage of the memory regions includes “for software” and “for image data”, and in the case that both memory regions neighboring at before and after the address of the unused memory region are in-use memory regions and the usage information of the both memory regions indicates “for software” and the usage of the requested memory region is “for image data”, the priority order of the unused memory regions is preferably set at a lower order.

In the embodiment described in Item 9, in the case that both memory regions neighboring at before and after the address of the unused memory region are the acquired regions “for software”, the probability that the unused memory regions is acquired as a memory region “for image data”, is made lower, thereby minimizing fragmentation in memory regions.

Item 10. In the memory administrating method described in Item 7, when the usage of the memory regions includes “for software” and “for image data”, and in the case that both memory regions neighboring at before and after the address of the unused memory region are in-use memory regions and the usage information of the both memory regions indicates “for image data” and the usage of the requested memory region is “for software”, the priority order of the unused memory regions is preferably set at a lower order.

In the embodiment described in Item 10, in the case that both memory regions neighboring at before and after the address of the unused memory region are the acquired regions “for image data”, the probability that the unused memory regions is acquired as a memory region “for software”, is made lower, thereby minimizing fragmentation in memory regions.

Item 11. In the memory administrating method described in Item 3, in the step of acquiring a requested memory region, the priority order of an unused region to be assigned as the requested memory region is preferably determined based on the time period information registered in the administrating portion for the acquired in-use memory regions.

In the embodiment described in Item 11, at the time of selecting and assigning which unused memory region to a requested memory region to be acquired, the priority order to each unused memory region is determined in accordance with a using time period of the acquired in-use memory region.

12. In the memory administrating method described in Item 11, the priority order of an unused region is preferably determined based on a comparison result between the time period information registered in the administrating portion of the acquired in-use memory regions positioned in the vicinity of the unused region and the using time period for using the requested memory region to be acquired.

In the embodiment described in Item 12, the priority order is determined based on the conformity of the using time period in comparison between the time period information of the acquired memory regions positioned in the vicinity of the unused region and the using time period of the memory region to be acquired. For example, when the time period information of both the acquired memory regions positioned before and after the unused region is different from the using time period of the memory region to be acquired from now, the priority order is made low. When the time period information of one of the acquired memory regions positioned before and after the unused region is same with the using time period of the memory region to be acquired from now and that of the other one is different from the using time period of the memory region to be acquired from now, the priority order is made middle. And, when the time period information of both the acquired memory regions is the same with that of the memory region to be acquired from now, the priority order is made high.

Namely, in the case that the time period information of both the acquired memory regions positioned before and after an unused region is the same with that of a memory region to be acquired from now, by preferentially using the unused region as an assigned region for the memory region to be acquire, the memory region is acquired such that memory regions having closer release timing are positioned close to each other. Therefore, when releasing a memory region, the memory region becomes to be easily united with a neighboring region, thereby minimizing fragmentation in memory regions. The memory regions in the vicinity of an unused region may not be limited to neighboring regions before and after the unused region and may be set to wider regions.

According to the memory administrating method mentioned above, since information regarding the usage or the using time period of a memory region is registered in correlation with the acquired memory region, assigning which unused region to a requested memory region to be acquired can be controlled by utilizing the information. Therefore, since the countermeasure to minimize fragmentation in memory region can be taken from a stage to acquire a memory region, the fragmentation in memory region can be refrained more efficiently.

The following describes the embodiments of the present invention with reference to drawings: Firstly, a description common to each embodiment is explained, thereafter, a description with reference to each embodiment is explained.

### DESCRIPTION COMMON TO EACH EMBODIMENT

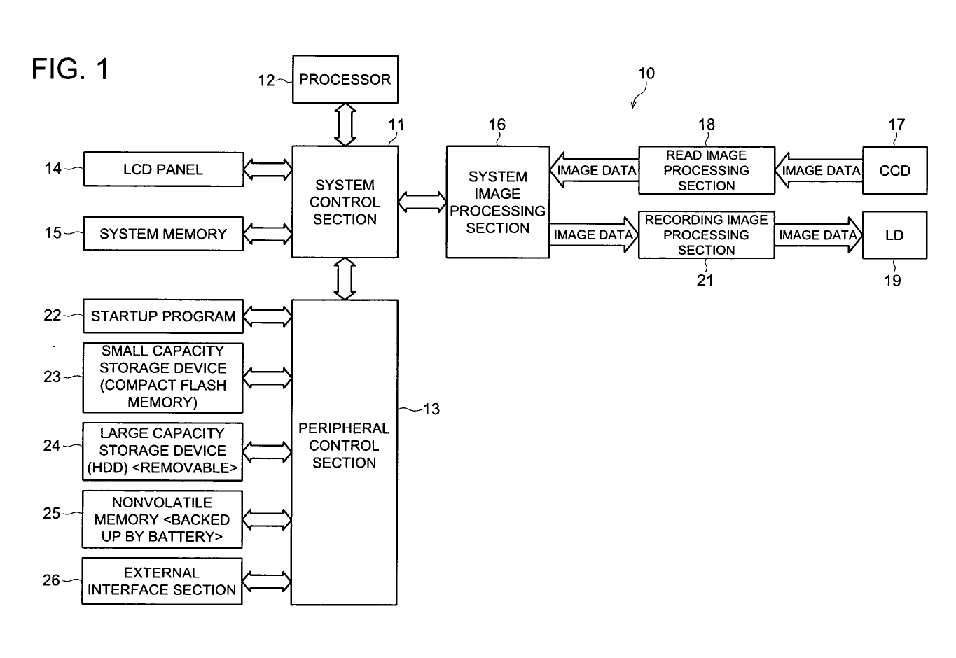

FIG. 1 shows the structure of the image forming apparatus 10 as an example of the apparatus based on the memory administrating method of the present invention. The image forming apparatus 10 is provided with a copying function of reading the document image, creating a reproduced image thereof on a recording sheet, and outputting the image. The image forming apparatus 10 is mainly structured with a system control section 11 for controlling the operation of the overall system, a processor 12 for performing the computation processing function; and a peripheral control section 13 for controlling various peripheral functions.

The system control section 11 is connected with a processor 12 and peripheral control section 13, as well as an LCD (Liquid Crystal Display) panel 14, system memory 15 and system image processing section 16. The LCD panel 14 is used to accept various operations by the user and to display on various operation screens and guide screen. The system memory 15 stores the operation program of the processor 12, and serves as a work memory for the processor 12 to execute the operation program and as a memory shared to store image data.

The system image processing section 16 is connected with a CCD (Charge Coupled Device) 17 as a device to read the document image through a read image processing section 18. It is also connected with an LD (Laser Diode) 19 of a laser printer method recording section through a recorded image processing section 21. In the document reading operation, the image data outputted from the CCD 17 is subjected to various processes of correction by the read image processing section 18, and is then inputted into the system image processing section 16. After being subjected to various image processing steps by the system image processing section 16, the image data is once stored in the system memory 15 through the system control section 11. In the operation of outputting to a recording sheet, the image data stored in the system memory 15 is read out by the system control section 11, and is imputed into the system image processing section 16, wherein the image data is subjected to various steps of image processing. After that, the image data is outputted to the LD 19 through the recorded image processing section 21.

The peripheral control section 13 is connected with a ROM (Read Only Memory) 22 with a startup program and others stored therein, small-capacity storage device 23, large-capacity storage device 24, nonvolatile memory 25 and external interface section 26. The small-capacity storage device 23 is used to store the control program and programs of a general-usage operating system. In this case, a flash memory is used as a small-capacity storage device 23. When the apparatus is started, the startup program in the ROM 22 is executed. Thus, the program in the small-capacity storage device 23 is executed in the system memory 15 to perform operations.

The large-capacity storage device 24 is structured with a hard disk apparatus and others, and is used to store image data. The nonvolatile memory 25 is used to store various parameters inherent to the apparatus. The external interface section 26 is connected with an external apparatus by various forms of communications method to control communications. For example, the LAN (Local Area Network), USB (Universal Serial Bus) and IEEE 1394 (Institute of Electrical and Electronic Engineers 1394) are used for this connection.

The image forming apparatus 10 has a memory administrating function to control acquisition and release of the memory region for the system memory 15. The memory administrating function is performed when the processor 12 executes the memory administrating program in the control program. In response to the request from other programs, the memory administrating program obtains the memory region of the requested size from the system memory 15, and sends it to the program of the source of request. Further, when a release command for the already obtained region is received from other programs, the relevant memory region is released as an unused region (vacant region).

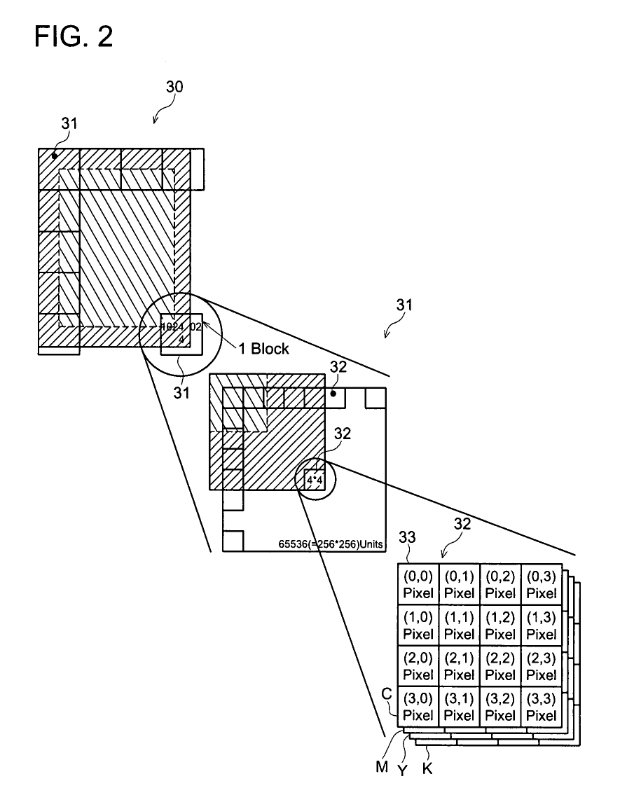

FIG. 2 shows an example of separating the image region into many blocks for processing. As shown in FIG. 2, the image forming apparatus 10 separates the image data into plural blocks for processing. In this example, the image data 30 for one page is separated into a total of 20 blocks obtained by multiplying 5 blocks in the vertical direction with 4 blocks in the horizontal direction. When each unit 32 is structured with an arrangement of 4×4 pixels 33, each of the blocks 31 is structured with a matrix of vertical 256 units by horizontal 256 units. When a color image is handled, each unit 32 contains a region of 4×4 pixels for each of the colors C (cyan), M (magenta), Y (yellow) and K (black). The actual size of the image data is somewhat smaller than the size of the region made up of vertical 5 blocks×horizontal 4 blocks. The peripheral block includes an extra region not used for image data storage.

To ensure that the region for storing the image data is effectively acquired from the system memory 15, it is preferred to acquire a continuous blocks for vertical 5 blocks. The memory region required in this case is for five blocks by 4. If continuous regions can be acquired for five each blocks in this manner, the extra size not used for image data storage in the acquired region is one fifth the size when acquired for each block. Further, when the system memory 15 does not contain a sufficient vacant region, a continuous region in the vertical direction should be acquired whenever possible. For example, if the region for 5 blocks is to be acquired as two separate regions—a region for 3 blocks and a region for 2 blocks, the size of the extra useless region can be reduced to two fifths the size when acquired for each block.

As described above, the memory region used to store the image data is required to have a greater region size than the region used for the work area for the execution of a program by the processor 12.

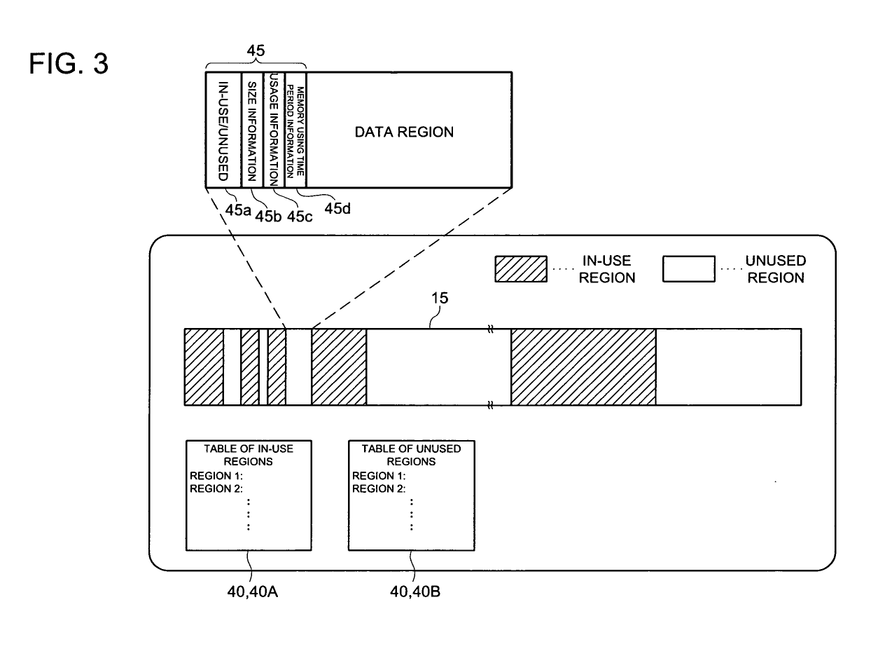

FIG. 3 shows an example of administration information with regard to an acquired memory region. In this example, as an administrating portion of a memory region, a header section 41 is provided as a head of an acquired memory region 40 and various kinds of administration information are stored in the header section 41. However, a memory administrating table is separately provided as the administrating portion, and the administration information with regard to each memory region may be registered in the memory administrating table and so as to administrate them.

As the administration information, status information 41a indicating valid/invalid (valid=in-use, invalid=unused) for memory assignment, size information 41b indicating a size of a memory region, usage information 41c indicating the usage of the memory region, and memory using time period information 41d with regard to a using time period of the memory region may be employed. Here, “usage information” is information to discriminate the usage of the memory region, and as the usage, “for storing image data” (hereinafter, referred as “for image data”), “for work-area at the time of executing program”, and “for storing program” may be employed.

“Memory using time period information” is information to discriminate the length of a time period from the acquisition of a memory region to a lease of the memory region. For example, date information to indicate release planning date, remaining time period information to indicate the remaining time period before release, information to indicate with plural stages (long term, mid-term, short term) for the length of the using time period may employed.

In FIG. 3, an acquired memory region (an in-use memory region) is indicated with a hatched area and an unused memory region is indicated with a white area without being hatched. Incidentally, an administrating portion is also provided to an unused region and information indicating valid/invalid for assignment, size and usage may be registered in this administrating portion.

Hereafter, various embodiments of acquiring process for a memory region among memory administrating functions for the system memory 15.

### First Embodiment

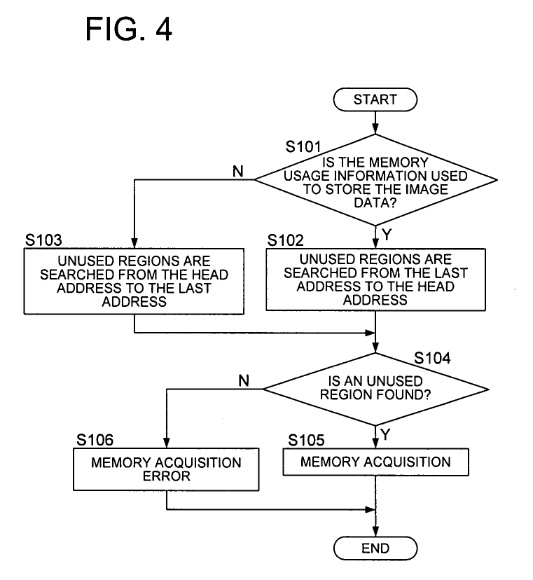

FIG. 4 shows the flow of a process of acquiring the memory region in a first embodiment. In this process, the method of searching the assigned region is determined in response to the usage of the requested memory region, and the assigned region is searched according to this determined search method. The usage information subsequent to acquiring the memory region is accepted, for example, as an index (parameter) for another process calling up the process of acquiring the memory region. After the region has been acquired, a check is made to determine if the memory region whose acquisition has been requested is used for image. If it is used for image (Step S101: Y), the first search method is determined, wherein an unused region is searched in the forward direction from the last address of the system memory 15 to a leading address. The memory region of the requested size is searched by the first search method (Step S102).

If the memory region whose acquisition has been requested is not used for image (Step S101: N), the second search method is determined, wherein an unused region is searched in the backward direction from the head address of the system memory 15 to a trailing address. The memory region of the requested size is searched by the second search method (Step S103).

When search is made by the search method having been determined, and the unused region of the size equal to or greater than the requested value has been found out (Step S104: Y), then the memory region whose acquisition has been requested this time is assigned from that unused region (Step S105). This process then terminates (End). When the memory region has been successfully acquired, the head address of the acquired memory region and related information are notified to the process on the source of request. Further, administration information is registered on the administrating portion of the acquired memory region. For example, header section 41 shown in FIG. 3 is created at the top position of the acquired memory region as a administrating portion, and usage information is registered on this header section 41.

If the unused region of the size equal to or greater than the requested value is not found out (Step S104: N), then the information indicating the failure of acquiring the memory region is sent to the source of request (Step S106), and this process then terminates (End).

This arrangement allows the memory region of the same usage to be assigned to a closer position. Thus, separation is observed based on usage within the system memory 15, and fragmentation is minimized.

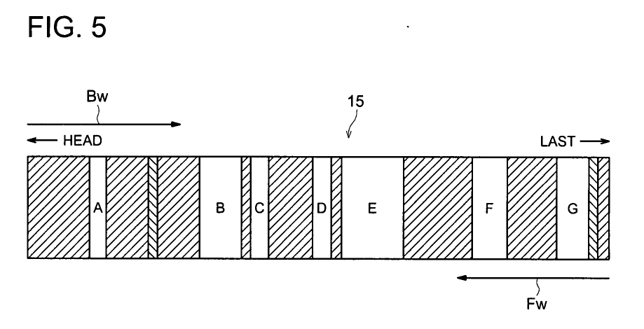

For example, to acquire a memory region for image when the system memory 15 is in the state shown in FIG. 5, unused regions are searched in the forward direction (shown by the arrow mark Fw in the drawing) from the last address. The unused regions G, F, E, D, C, B and A are searched in that order, and memory regions are assigned. Conversely, when a memory region not for image is acquired, unused regions A, B, C, D, E, F and G are searched in that order (shown by the arrow mark Bw in the drawing), and the memory region is assigned. Thus, the memory region acquired for image and the memory region acquired for other usage are naturally separated to the end portion and head portion of the system memory 15. This eliminates the possibility of the mixed presence of the regions of different sizes, thereby minimizing the fragmentation of the memory (unoccupied region).

In the aforementioned example, usage is classified into two types; one for image and the other for others. The classification of the usage as a reference for determining the method of search is not restricted thereto. When the search method is determined according to the using time period, it can be determined in the same way as that of usage. For example, the using time period is classified into two types; long-term period and short-term period. In the case of the long-term period, the unused regions are searched from the head of the memory to the end. In the case of the short-term period, the unused regions are searched from the end of the memory to the head.

Further, one of the usage and the using time period is used to a reference for determining the method of search, and thereafter, the other one is used to a reference for determining the method of search, and the usage and the using time period may be registered in the administrating portion of the acquired memory region.

### Second Embodiment

In the second Embodiment, in the process of acquisition, the priority of the unused region at the time of selecting the source of acquisition of the unused region of the assigned region (an unused region to be assigned as a requested memory region) is determined according to the information on the using time period of the already acquired memory region (an acquired in-use memory region). Unused regions are searched according to the determined priority, whereby the memory region is assigned.

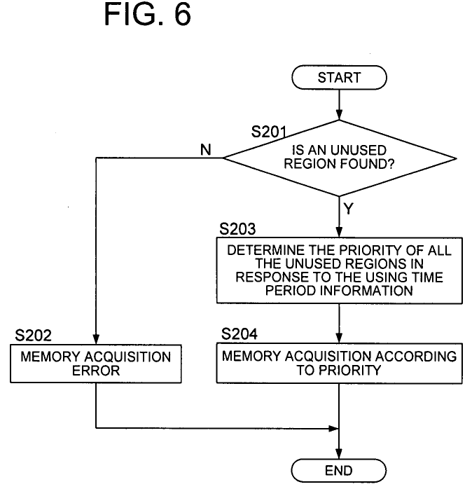

FIG. 6 shows an example of the flow in the process of acquiring the memory region in the second Embodiment. In this example, the priority of the unused region is determined according to the result of comparison between the using time period of the already acquired memory regions positioned before and after the unused region and the using time period of the memory region whose acquisition has been requested. The information on the using time period of the memory region whose acquisition has been requested is delivered, for example, as an index (parameter) at the time of another process calling up the process of acquiring the memory region. The using time period of the already acquired memory region is identified by the memory using time period information in the administration information registered on the administrating portion of the memory region. For example, it is identified by the memory using time period information 41d of a header section 41 shown in FIG. 3.

In the process of acquisition, a check is made to see if continuous unused regions of the size equal to or greater than the requested value are present in the system memory 15 or not (Step S201). If they are not present (Step S201: N), the information indicating the failure of acquiring the memory region is sent to the source of request (Step S202), and this process then terminates (End).

If the continuous unused regions of the size equal to or greater than the requested value are present in the system memory 15 (Step S201: Y), the priority of all the relevant unused regions is determined according to the result of comparison between the using time period of the already acquired memory regions positioned before and after the unused regions and the using time period of the memory region whose acquisition has been requested (Step S203). The memory region of the requested size is assigned from the unused regions in the higher order of priority (Step S204), and the process then terminates (End).

When the memory region has been successfully acquired, the head address of the acquired memory region and related information are notified to the source of request. Further, information on the using time period of the relevant acquired memory region is registered on the administrating portion of the acquired memory region. In this case, the header section 41 shown in FIG. 3 is created at the top position of the acquired memory region, and the memory using time period information 41d and others are registered on this header section 41.

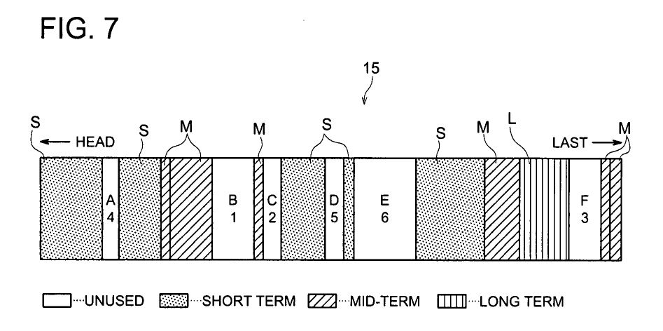

The specific operation in the aforementioned acquiring process will be described with reference to the system memory 15 in the state shown in FIG. 5. In FIG. 7, the already acquired memory region (in-use memory region) is crosshatched and the unused region is shown in white. Further, the region L denotes the already acquired memory region of long-term using time period, the region M indicates the already acquired memory region of mid-term using time period, and the region S represents the already acquired memory region of short-term using time period.

For example, when the mid-term using time period memory region is acquired from the system memory 15 in the state of FIG. 7, any one of the unused regions A, D and E is surrounded before and after by the regions S of short-term using time period. When the mid-term memory region is acquired from the unused regions A, D and E, even if the short-term memory regions S positioned before and after are released relatively soon, the mid-term memory region having been acquired during this time period cannot be released soon. These unreleased regions tend to hinder formation of a continuous unused region, and hence tend to cause fragmentation. Thus, the unused regions A, D and E having the using time period of this nature are assigned with lower priority.

In the meantime, the unused region B is surrounded before and after by the already acquired regions M having the using time period of the same level as that (mid-term) of the memory region whose acquisition has been requested. When the mid-term memory region is acquired from this unused region B, the acquired memory region is released at almost the same time as the regions M positioned before and after. Thus, the unused region B having the using time period of this nature is assigned with higher priority.

Both the unused regions C and F are the unused regions surrounded before and after by the already acquired regions of different using time period. One of the regions before and after is an already acquired mid-term region M. Thus, the priority intermediate between the priority assigned to the unused region B and priority assigned to the unused regions A, D and E is set.

In the example of FIG. 7, priority is determined by comparison of the using time periods. At the same time, when there are two or more unused regions of the same priority, more detailed priority is set among these unused regions of the same priority according to the rule of assigning “a higher priority to the region closer to the head position of the memory”. The numerals “1” through “6” of the unused region in FIG. 7 indicate the priority (a higher priority assigned to a smaller numeral) determined in this manner.

When there are plural of unused regions having the same priority based on the using time period, the more detailed priority among these unused regions can be determined according to the method used in the first Embodiment. For example, when the memory region to be acquired has a short-term using time period, the unused region having the same priority by comparison of the using time periods can be assigned with priority from the head of the memory in the backward direction. When the memory region to be acquired has an mid-term or long-term using time period, priority can be assigned from the end of the memory to the top position.

Further, when there are plural unused regions having the same priority based on the using time period, the priority may be determined by the usage.

As described above, information on the using time period of the memory region is compared, and the memory region is assigned on the priority basis from the unused region surrounded by the already acquired memory region having the same or approximate using time period. The memory regions which are similar with respect to the timed interval for release are arranged close to one another. This arrangement reduces the probability that memory regions kept unreleased for a long time should be contained among the released regions, and hence minimizes memory fragmentation.

### Third Embodiment

In the third Embodiment, in the process of acquiring memory regions, the priority of the unused region at the time of selecting the source of acquiring the assigned region is determined based on the result of comparison between the usage of the already acquired memory region positioned before and after the unused region, and the usage of the memory region whose acquisition has been requested. Unused regions are searched according to the determined priority, and the memory region is assigned.

The flow of the process of acquiring the memory region of the third Embodiment is different from the flow is shown in FIG. 6 in that the priority is determined according to the usage information, instead of the priority being determined according to the using time period in Step S203. Otherwise, there is no difference. To avoid duplication, the flow chart and detailed description of processing will be omitted. It should be noted that the information on the usage of the memory region whose acquisition has been requested is accepted as an index (parameter) for another process calling out the process of acquisition, for example. The usage of the already acquired memory region is identified by the usage information in the administration information registered in the administrating portion corresponding to that memory region. For example, it is identified by the usage information 41c of the header section 41 of FIG. 3.

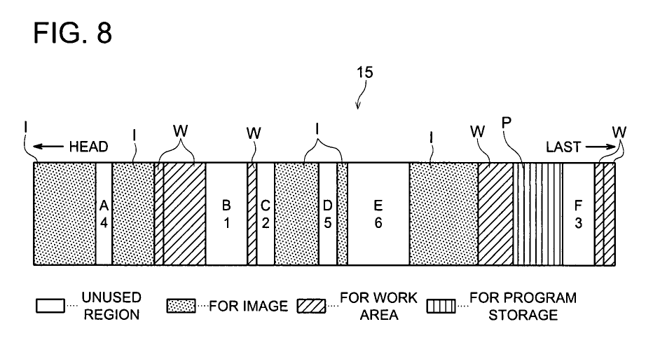

A specific example of the process of acquiring the memory region in the third Embodiment will be described with reference to FIG. 8. In FIG. 8, the already acquired memory region (in-use memory region) is crosshatched and the unused region is shown in white. The region I indicates the already acquired memory region having the usage for image, the region W denotes the already acquired memory region having the usage for processor work area, and the region P represents the already acquired memory region having the usage for program storage.

For example, when a memory region for work area is to be acquired from the system memory 15 in the state of FIG. 8, any one of the unused regions A, D and E is surrounded before and after with the region I for image. If the memory region for work area is acquired from unused regions A, D and E, after the memory regions I for image positioned before and after have been released, the memory region for work area acquired during this time is not released for a long time. The unreleased region tends to hinder formation of a continuous unused region, and hence tends to cause fragmentation. Thus, the unused regions A, D and E having the using time period of this nature are assigned with lower priority.

In the meantime, the unused region B is surrounded before and after by the already acquired regions M having the same usage (for work area) as that of the memory region whose acquisition has been requested. When the work area memory region is acquired from this unused region B, the acquired memory region is released at almost the same time as the regions W positioned before and after. Thus, the unused region B having the using time period of this nature is assigned with higher priority.

Both the unused regions C and F are unused regions surrounded before and after with the already acquired regions having different usages. One of them is the already acquired region W for work area. Thus, the priority intermediate between the priority assigned to the unused region B and priority assigned to the unused regions A, D and E is set.

In the example of FIG. 8, priority is determined by comparison of usage. At the same time, when there are two or more unused regions of the same priority, more detailed priority is set among these unused regions of the same priority according to the rule of assigning “a higher priority to the region closer to the head position of the memory”. The numerals “1” through “6” of the unused region in FIG. 8 indicate the priority (a higher priority assigned to a smaller numeral) determined in this manner.

When there are a plurality of unused regions having the same priority determined according to comparison of usage, the more detailed priority among these unused regions can be determined according to the method used in the first Embodiment. For example, when the memory region to be acquired has a usage for image, the unused region having the same priority by comparison of the usage can be assigned with priority from the head of the memory in the backward direction. When the memory region to be acquired has the usage other than for image, priority can be assigned from the end of the memory to the top position.

Further, when there are plural unused regions having the same priority based on the usage, the priority may be determined by the using time period.

As described above, information on the usage of the memory region is compared, and the memory region is assigned on the priority basis from the unused region surrounded by the already acquired memory region having the same or approximate usage. The memory regions which are similar with respect to the timed interval for release and the size of the region are arranged close to one another. This arrangement reduces the probability that that already acquired memory regions of smaller size are present among larger unused regions or the memory region unreleased for a long time is present, and hence minimizes memory fragmentation.

The following describes the case of acquiring the region according to the algorithm wherein, if both the adjacent memory regions before and after are already acquired regions having the same usage and the usage is different from the usage of the memory region whose acquisition has been requested, then the priority for the unused region is lowered.

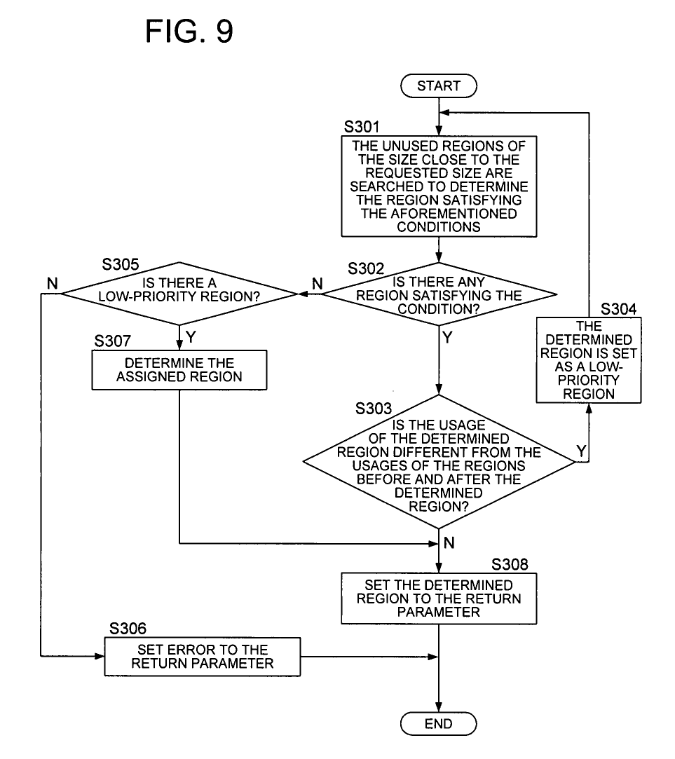

FIG. 9 shows the flow of the process of acquiring the memory region based on the aforementioned algorithm. The information showing the usage of the memory region whose acquisition has been requested is accepted as an index (parameter) for another process calling out the process of acquisition, for example. The usage of the already acquired memory region is identified by the usage information in the administration information registered in the administrating portion corresponding to that memory region. For example, it is identified by the usage information 41c of the header section 41 of FIG. 3.

In this case, usage is classified into two types—usage for software and usage for image.

In the first place, the unused regions of the size close to the requested size (the smallest size equal to or greater than the requested size) are searched, and any one of the unused regions meeting the aforementioned conditions is determined (Step S301). If there is an unused region (determined region) meeting the aforementioned condition (Step S302: Y), a check is made to examine the usage of the adjacent acquired memory region (in-use region) before and after the aforementioned determined region. If the usages of these already acquired memory regions positioned before and after are the same with one another and are different from the usages of the memory region to be acquired (Step S303: Y), the aforementioned determined region is set as a low-priority region (Step S304). After that, the system goes back to Step S301 to find out the next determined region. It should be noted that the low-priority region is not found out in Step S301.

For example, if the already acquired memory regions positioned before and after are used for software, and the memory region whose acquisition has been requested is used for image, then the aforementioned determined region is set to the low-priority region. If the adjacent already acquired regions before and after the determined region are used for image and the memory region whose acquisition has been requested is used for software, the aforementioned determined region is also set to the low-priority region.

If at least one of the usages of the already acquired memory regions positioned before and after the determined region is the same as the usage of the memory region to be acquired (Step S303: N), the aforementioned determined region is finally determined as the unused regions for the source of acquiring the assigned region in the process of acquisition of this time. The region covering the size requested from the aforementioned unused regions is acquired as an assigned region, and the head address and size of the aforementioned assigned region are notified to the process at the source of request by setting the determined area to the parameter for return (Step S308). Then this process terminates (End).

For example, if one of the already acquired memory regions positioned before and after the determined region is used for software and the other is used for image, the assigned region is acquired from the aforementioned determined region. Further, if both the already acquired regions before and after the determined region are used for software and the memory region whose acquisition has been requested is also used for software, or if both the already acquired regions before and after the determined region are used for image and the memory region whose acquisition has been requested is also used for image, the assigned region is acquired from the aforementioned determined region.

If there is no determined region meeting the condition of Step S301 (Step S302: N), a check is made to examine if there is an unused region set to a low-priority region in Step S304 (Step S305). If there is no such a region (Step S305: N), error information indicating the region acquisition failure is notified to the process at the source of request (Step S306). The process then terminates (End).

If there is an unused region set as a low-priority region (Step S305: Y), the assigned region is determined from the aforementioned low-priority region (Step S307), and the head address and size of the determined region are notified to the source of request (Step S308). The process then terminates (End).

In the low-priority region, the usages of the already acquired regions before and after are the same with each other, and the aforementioned usage is different from that of the memory region whose acquisition has been requested. Accordingly, if the memory is acquired from the low-priority region, the memory of different usage is acquired in such a way that this memory breaks in the in-use regions of the same usage. This will cause a difference in the timing for releasing, and reduces the possibility of the adjacent memory regions being combined into one piece at the time of releasing. Thus, if the in-use regions before and after the unused region have the same usage, and their usage is different from the usage of the memory region to be acquired, then the unused region is set to a low priority to ensure that the assigned region will not be acquired from the aforementioned unused region, wherever possible.

The embodiment of the present invention has been described with reference to drawings. It is to be expressly understood, however, that the present invention is not restricted to the structures given in the embodiments. The present invention can be embodied in a great number of variations with appropriate modification or additions, without departing from the technological spirit and scope of the invention claimed.

For example, the system memory 15 has been described using the example of handling the memory management function. It can be any memory if it is capable of dynamic releasing and acquisition.

In the first Embodiment, the direction of search is changed in response to the usage and using time period, thereby determining whether the search should be made from the head of the memory to the end, or from the end to the head. However, the method of search in response to the usage and using time period is not restricted to this arrangement alone. For example, in response to the usage and using time period, it is possible to switch between (1) the method of finding out the unused region of the fittest size on the priority basis, and (2) the method of finding out the unused regions in descending order of size on the priority basis. Further, it is also possible to make such arrangements that the search method is determined with consideration given to both the using time period and usage.

Further, the above description of the second Embodiment contains the example wherein a high priority is assigned when the using time period of the memory region to be acquired agrees with both the using time period of the already acquired memory region before and after the unused regions, a mid priority is assigned when it agrees with one of them, and a low priority is assigned when it differs from both of them. However, it is to be understood that the standard for determining the priority based on the using time period is not restricted to the aforementioned one.

For example, comparison is made between the using time period of the memory region whose acquisition has been requested and the using time period of the already acquired memory region before and after the unused regions. If the former is shorter than the latter, the level of priority is raised. If the former is longer than the latter, the level of priority is lowered. Based on such a standard, priority can be determined. To be more specific, if the using time period of the adjacent acquired memory regions is longer than the using time period of the memory region to be acquired, the memory region to be acquired is more likely to be released earlier. Accordingly, even if the memory region of shorter using time period is acquired at a position close to the already acquired region of longer using time period, the presence of the aforementioned acquired memory region is less likely to hinder the formation of a continuous region.

For example, when a mid-term memory region is to be acquired, the unused region C of FIG. 7 is surrounded by the mid-term using time period already acquired region M and short-term already acquired region S. The unused region F is surrounded with the already acquired long using time period region L and already acquired mid-term region M. In this case, on condition that there is an agreement of the using time period only with one of the regions positioned before and after, the priority is on the same level. For the unused region, the other of the regions before and after is adjacent with the already acquired long-term region L. Thus, a higher priority is given to the unused region F than to the unused region C adjacent to the short-term already acquired region S. This arrangement raises the possibility that, when the short-term memory region S adjacent to the unused region C is released, one larger unused region is created by combination with the unused region C. This will further reduce the possibility of memory fragmentation.

In the Embodiment, priority is determined based on the regions before and after the unused region. Priority can also be determined based on the surrounding objects over the more extensive range. For example, when the adjacent already acquired region has a smaller size, priority can be determined using the further adjacent already acquired regions as well. Further, the regions included in the scope of predetermined addresses before and after the unused region can be employed to determine the level of priority.

Without being restricted to the semiconductor memory, the memory as an object of the memory management method of the present invention can be applied to a storage apparatus such as a hard disk apparatus.

What is claimed is:

1. A memory administrating method of administrating a memory divided into plural memory regions each of which consists of consecutive memory addresses, comprising steps of:
acquiring a memory region from the plural memory regions; and
registering at least one of usage information indicating the usage of the acquired memory region and time period information indicating the using time period for using the acquired memory region in an administrating portion of the acquired memory region.

2. The memory administrating method described in claim 1, wherein the usage information indicating the usage of the acquired memory region is registered in the administrating portion of the acquired memory region.

3. The memory administrating method described in claim 1, wherein the time period information indicating the using time period for using the acquired memory region is registered in the administrating portion of the acquired memory region.

4. The memory administrating method described in claim 2, wherein in the step of acquiring a requested memory region, a searching method of searching an assigned region to be assigned as the requested memory region is determined in accordance with the usage of the requested memory region.

5. The memory administrating method described in claim 3, wherein in the step of acquiring a requested memory region, a searching method of searching an assigned region to be assigned as the requested memory region is determined in accordance with the using time period for using the requested memory region.

6. The memory administrating method described in claim 2, wherein in the step of acquiring a requested memory region, the priority order of an unused region to be assigned as the requested memory region is determined based on the usage information registered in the administrating portion of the acquired in-use memory regions.

7. The memory administrating method described in claim 6, wherein the priority order of an unused region is determined based on a comparison result between the usage information registered in the administrating portion of the acquired in-use memory regions positioned in the vicinity of the unused region and the usage of the requested memory region to be acquired.

8. The memory administrating method described in claim 7, wherein in the case that both memory regions neighboring at before and after the address of the unused memory region are in-use memory regions and the usage information of the both memory regions are the same with each other and are different from the usage of the requested memory region, the priority order of the unused memory regions is set at a lower order.

9. The memory administrating method described in claim 7, wherein when the usage of the memory regions includes “for software” and “for image data”, and in the case that both memory regions neighboring at before and after the address of the unused memory region are in-use memory regions and the usage information of the both memory regions indicates “for software” and the usage of the requested memory region is “for image data”, the priority order of the unused memory regions is set at a lower order.

10. The memory administrating method described in claim 7, wherein when the usage of the memory regions includes “for software” and “for image data”, and in the case that both memory regions neighboring at before and after the address of the unused memory region are in-use memory regions and the usage information of the both memory regions indicates “for image data” and the usage of the requested memory region is “for software”, the priority order of the unused memory regions is set at a lower order.

11. The memory administrating method described in claim 3, wherein in the step of acquiring a requested memory region, the priority order of an unused region to be assigned as the requested memory region is determined based on the time period information registered in the administrating portion of the acquired in-use memory regions.

12. The memory administrating method described in claim 11, wherein the priority order of an unused region is determined based on a comparison result between the time period information registered in the administrating portion of the acquired in-use memory regions positioned in the vicinity of the unused region and the using time period for using the requested memory region to be acquired.
